(19) United States
(12) Patent Application Publication
(10) Pub. No.: US 2006/0232998 A1
(43) Pub. Date: Oct. 19, 2006

(54) Light guide plate and backlight module having the same

(75) Inventors: Ming-Hung Tsai, Miao-Li (TW); Wu-Hong Fang, Shenzhen (CN)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/403,594

(22) Filed: Apr. 13, 2006

(30) Foreign Application Priority Data
Apr. 15, 2005 (TW) 94112025

(51) Int. Cl. F21V 7/04

(52) U.S. Cl. 362/621; 362/622; 362/608

(57) ABSTRACT

A backlight module (10) includes a light guide plate (100) and a light source (110). The light guide plate includes a light incident surface (102). The light incident surface includes a plurality of dots (108) provided thereat. The light source is disposed adjacent to the light incident surface. A sum of a size of one dot and a pitch between adjacent dots is less than 380 nm. The backlight module can obtain optimized optical performance.

### FIELD OF THE INVENTION

The present invention relates to light guide plates, and more particularly to a light guide plate for a backlight module.

### GENERAL BACKGROUND

Liquid crystal displays (LCDs) are commonly used as display devices for compact electronic apparatuses, because they not only provide good quality images with little power but are also very thin. The liquid crystal molecules in a liquid crystal display do not emit any light themselves. The liquid crystal molecules have to be lit by a light source so as to clearly and sharply display text and images. Thus, a backlight module is generally needed for an LCD.

One kind of conventional backlight module generally includes a light guide plate. The light guide plate has a light incident surface through which light beams enter from the outside. However, total reflection of at least some light beams may occur at the light incident surface, which results in a reduced light utilization ratio.

Thus in another kind of conventional backlight module, a plurality of dots are formed on a light incident surface of a light guide plate of the backlight module. The dots reduce or eliminate total reflection, and thus can improve a light utilization ratio of the backlight module. However, for a typical light source used with the light guide plate, the light beams emitted from the light source are in the visible spectrum, and comprise a plurality of light beams of different colors mixed together. At the light incident surface of the light guide plate, a size of each dot and a pitch between two adjacent dots are very small. Therefore when light beams strike the light incident surface with an incident angle over 30 degrees, some blue light beams are lost due to diffraction. Thus light beams entering the light guide plate appear a little yellow, which results in an uneven color balance of light output by the backlight module.

What is needed, therefore, is a light guide plate that can overcome the above-described deficiencies.

### SUMMARY

A backlight module includes a light guide plate and a light source. The light guide plate includes a light incident surface. The light incident surface includes a plurality of dots provided thereat. The light source is disposed adjacent to the light incident surface. A sum of a size of one dot and a pitch between adjacent dots is less than 380 nm.

Other advantages and novel features will become more apparent from the following detailed description when taken in conjunction with the accompanying drawings. In the drawings, all the views are schematic.

### BRIEF DESCRIPTION OF THE DRAWINGS

FIG. 1 is an isometric view of a backlight module according to a first embodiment of the present invention.

FIG. 2 is an enlarged, top view of dots formed on a light guide plate of the backlight module of FIG. 1, showing dimensions and light diffraction characteristics thereof.

FIG. 3 is an isometric view of a backlight module according to a second embodiment of the present invention.

FIG. 4 is an isometric view of a backlight module according to a third embodiment of the present invention.

FIG. 5 is an isometric view of a backlight module according to a fourth embodiment of the present invention.

### DETAILED DESCRIPTION OF PREFERRED EMBODIMENTS

Reference will now be made to the drawings to describe the preferred embodiments in detail.

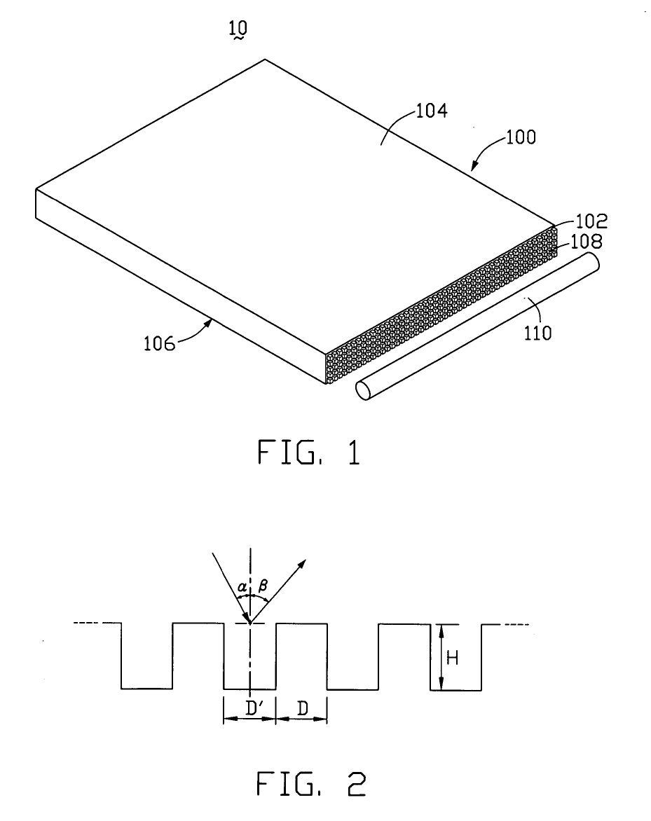

FIG. 1 is a schematic, isometric view of a backlight module according to a first embodiment of the present invention. The backlight module 10 includes a rectangular light guide plate 100 and a light source 110. The light guide plate 100 includes a light incident surface 102 having a plurality of block-shaped dots 108 formed thereon, a light emitting surface 104 adjoining the light incident surface 102, and a bottom surface 106 opposite to the light emitting surface 104. The dots 108 protrude from the light incident surface 102, and are arranged in a rectangular matrix known generally as a moth-eye pattern. The light source 110 is disposed adjacent to the light incident surface 102 of the light guide plate 100, and in the illustrated embodiment is a cold cathode fluorescent lamp (CCFL). The light guide plate 100 can be made from polycarbonate (PC) or polymethyl methacrylate (PMMA).

Referring to FIG. 2, if diffraction of a visible light beam occurs at the light incident surface 102, the following equation (1) governs characteristics of the diffraction:
sin α=sin β+n*λ/(D+D′) (n=1, 2, 3 . . . ) (1)
wherein α is an incident angle of the light beam, β is a diffraction angle of the light beam, λ is a wavelength of the light beam, n is an order of diffraction, D is a width of each dot 108, and D′ is a pitch between two adjacent dots 108.

Because sin α a and sin β are both in a range from 0 to 1, the following formula (2) can be derived:
λ/(D+D′)≦1 (2)

Because the wavelength λ of visible light is in the range from 380 nm to 780 nm, the summation of D and D′ must be less than 380 nm to prevent diffraction.

What has been confirmed by experiments is that the backlight module 10 can achieve good anti-diffraction and anti-reflection performance when the following formula (3) is employed:
λ/(D+D′)≧2 (3)

That is, for optimized performance, the sum of D and D′ is less than or equal to a half of λ, wherein λ has a minimum wavelength of 380 nm. Further, it is relatively easy to manufacture the light guide plate 100 when D and D′ are each 95 nm.

A height H of each dot 108 is generally dependent on a ratio of H to the summation of D and D′. Good transmission performance can be obtained when H is 1.25 times the sum of D and D′. An attenuation ratio of 0.5% is obtained when H is 0.8 times the sum of D and D′, which has been confirmed by experiments.

The light guide plate 100 includes a plurality of dots 108 formed on the light incident surface 102 with desired pitches and sizes. The dots 108 can reduce or even eliminate total reflection of light beams striking the light incident surface 102. In addition, when the dots 108 are suitably sized and suitably spaced apart, diffraction at the light incident surface 102 can be reduced or even eliminated. Thus, the backlight module 10 can achieve optimized optical performance.

In an alternative embodiment, the pitch between two adjacent dots 108 can be controlled to be in a certain range according to the particular optical requirements of a given application. In another alternative embodiment, the backlight module 10 can further include a prism sheet (not shown) disposed adjacent to the light emitting surface 104 of the light guide plate 100, and a reflective sheet (not shown) disposed adjacent to the bottom surface 106 of the light guide plate 100. In a further alternative embodiment, the light source 110 can be one or more light emitting diodes (LEDs).

FIG. 3 is a schematic, isometric view of a backlight module according to a second embodiment of the present invention. The backlight module 20 is similar to the backlight module 10. However, the backlight module 20 has a plurality of conical dots 208 formed on a light incident surface 202 of a light guide plate 200 thereof. A tip of each conical dot 208 points away from the light incident surface 202.

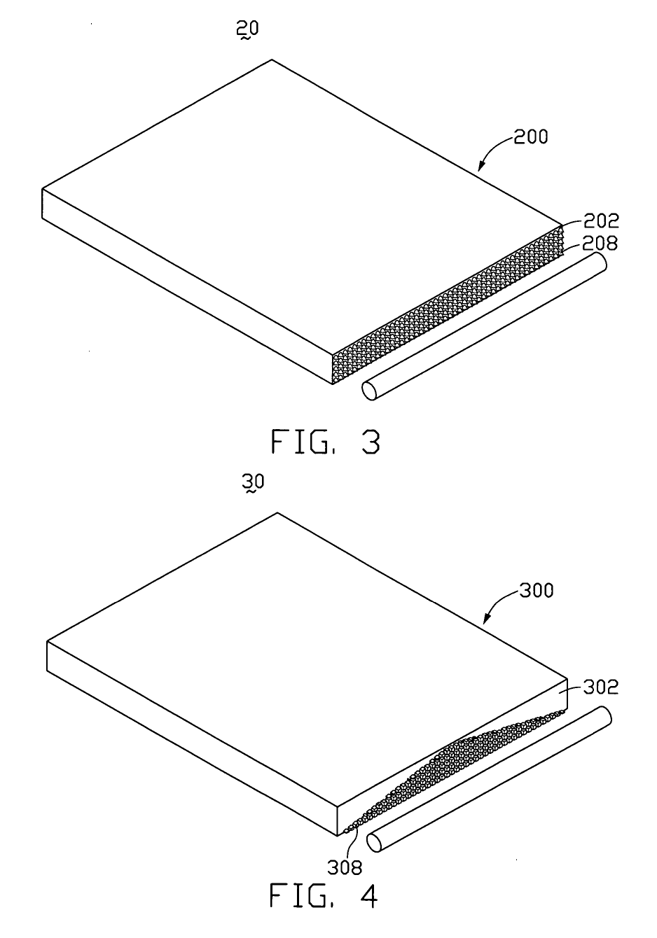

FIG. 4 is a schematic, isometric view of a backlight module according to a third embodiment of the present invention. The backlight module 30 is similar to the backlight module 10. However, the backlight module 30 has a triangular matrix of block-shaped dots 308 formed on a light incident surface 302 of a light guide plate 300 thereof. The triangle is substantially an isosceles triangle. Two symmetrically opposite points of the triangle are respectively adjacent two bottom corners of the light incident surface 302. The other point of the triangle is substantially adjacent a midpoint of a top extremity of the light incident surface 302.

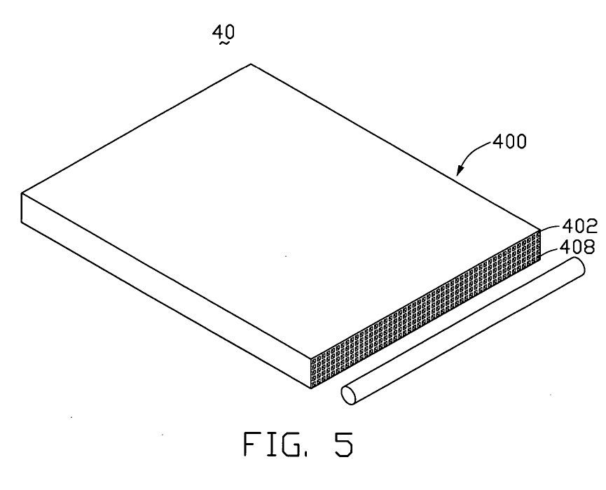

FIG. 5 is a schematic, isometric view of a backlight module according to a fourth embodiment of the present invention. The backlight module 40 is similar to the backlight module 10. However, the backlight module 40 has a plurality of dots 408 formed at a light incident surface 402 of a light guide plate 400 thereof. Each dot 408 comprises a block-shaped recess. The dots 408 are arranged in a rectangular matrix.

The backlight modules 20, 30 and 40 have advantages similar to those described above in relation to the backlight module 10 of the first embodiment. In alternative embodiments, the light incident surface 202, 302 and 402 may have a plurality of frustum-shaped dots, pyramidal dots (e.g., with three or four sides), or frustum-shaped pyramids. Further, other alternative embodiments of the backlight modules 20, 30 and 40 can be similar to the alternative embodiments described above in relation to the backlight module 10 of the first embodiment. In still further alternative embodiments, the backlight modules each may include a light guide plate having two or more light incident surfaces such as any of those described above, and corresponding light sources.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A light guide plate comprising a light incident surface having a plurality of dots provided thereat, wherein a sum of a width of one dot and a pitch between adjacent dots is less than 380 nm.

2. The light guide plate as claimed in claim 1, wherein the sum of the width of one dot and the pitch between adjacent dots is less than or equal to 190 nm.

3. The light guide plate as claimed in claim 2, wherein the width of one dot is substantially equal to the pitch between adjacent dots.

4. The light guide plate as claimed in claim 3, wherein the width of one dot is approximately 95 nm.

5. The light guide plate as claimed in claim 1, wherein a length of each dot is in the range from 0.8 to 1.25 times the sum of the width of one dot and the pitch between adjacent dots.

6. The light guide plate as claimed in claim 5, wherein the length of each dot is substantially 1.25 times the sum of the width of one dot and the pitch between adjacent dots.

7. The light guide plate as claimed in claim 1, wherein each dot is block-shaped.

8. The light guide plate as claimed in claim 1, wherein each dot is conical.

9. The light guide plate as claimed in claim 8, wherein a tip of each dot points away from the light incident surface.

10. The light guide plate as claimed in claim 1, wherein the plurality of dots are arranged in a substantially rectangular matrix.

11. The light guide plate as claimed in claim 1, wherein the plurality of dots are arranged in a substantially triangular matrix.

12. The light guide plate as claimed in claim 1, wherein the dots protrude from the light incident surface.

13. The light guide plate as claimed in claim 1, wherein each of the dots comprises a recess.

14. The light guide plate as claimed in claim 1, wherein the light guide plate is made from polycarbonate.

15. The light guide plate as claimed in claim 1, wherein the light guide plate is made from polymethyl methacrylate.

16. A backlight module, comprising:
a light guide plate comprising a light incident surface, the light incident surface comprising a plurality of dots provided thereat; and
a light source disposed adjacent to the light incident surface;
wherein a sum of a size of one dot and a pitch between adjacent dots is less than 380 nm.

17. The backlight module as claimed in claim 16, wherein the light source is a cold cathode fluorescent lamp.

18. The backlight module as claimed in claim 16, wherein the light source is one or more light emitting diodes.

19. A light guide plate comprising a light incident surface having a plurality of dots provided thereat, wherein a height of the dot is 1.25 times a sum of a width of one dot and a pitch between adjacent dots.
